(19) United States
(12) Patent Application Publication
(10) Pub. No.: US 2015/0096042 A1
(43) Pub. Date: Apr. 2, 2015

(54) METHOD AND APPARATUS FOR IMPROVED PRIVATE MESSAGING

(71) Applicant: Innovative Venture, S.A. a Panama Corporation, Panama (PA)

(72) Inventor: Mayer Mizrachi, Aventura, FL (US)

(73) Assignee: Innovative Venture, S.A. a Panama Corporation, Panama (PA)

(21) Appl. No.: 14/044,833

(22) Filed: Oct. 2, 2013

(51) Int. Cl. H04L 29/06

(52) U.S. Cl. CPC H04L 63/0421
USPC 726/26

(57) ABSTRACT

An improved method and apparatus for private messaging is disclosed. In one embodiment, a first device transmits a message to a second device via a server. The message is displayed on the second device without any identification of the sender, and the message disappears after a predetermined time period and is permanently deleted from the first device, second device, and server. In another embodiment, the second device sends communications to the server indicating that the second device received the message, opened the message, and deleted the message, and the server sends those communications to the first device.

An improved method and apparatus for private messaging is disclosed. In one embodiment, a first device transmits a message to a second device via a server. The message is displayed on the second device without any identification of the sender, and the message disappears after a predetermined time period and is permanently deleted from the first device, second device, and server. In another embodiment, the second device sends communications to the server indicating that the second device received the message, opened the message, and deleted the message, and the server sends those communications to the first device.

### BACKGROUND OF THE INVENTION

Text messaging using mobile devices is well known in the prior art. Using SMS or MMS technology, the user of one mobile device can send a message to another mobile device. In the prior art, the SMS or MMS message contains the name of the sender and/or the sender's phone number, and the name or phone number usually is displayed on the recipient's device along with the message. SMS and MMS messages are stored indefinitely on the recipient's device until the recipient chooses to delete it.

Also known in the prior art is instant messaging, where a user sends a message to another user over the Internet. Again, the message itself contains the name of the sender or his or her user name. Instant messages are stored indefinitely on the recipient's computer and/or account until the recipient chooses to delete it.

One drawback in the prior art is that the sender of each message is always readily identifiable from the message itself, either by visual inspection of the display or by analysis of the data itself. If the recipient takes a screen shot of the message and forwards it to others, it will be apparent who the sender of the original message was. Another drawback is that messages can be stored indefinitely on devices other than the sender's. That is, each message potentially could survive indefinitely.

What is needed is an improved transmission system where the identity of the sender is not apparent from the message or display. What is further needed is an improved transmission system where each message is not stored on the recipient's device or computer and is automatically deleted after a certain time interval.

### SUMMARY OF THE INVENTION

The aforementioned problems and needs are addressed by an improved transmission system that displays no identification information with each message and that automatically deletes the message from the recipient's device after a certain time interval. This system provides increased privacy and security compared to the prior art.

### BRIEF DESCRIPTION OF THE DRAWINGS

FIG. 1 is an exemplary block diagram of an embodiment involving communication between two devices.

FIG. 2 is an exemplary screenshot of a login screen on a device.

FIG. 3 is an exemplary screenshot of a conversation initiation screen on a device.

FIG. 4 is an exemplary message creation screen on a transmitting device.

FIG. 5 is an exemplary prompting screen on a receiving device.

FIG. 6 is an exemplary message review screen on a receiving device.

FIG. 7A and 7B are exemplary depictions of a first packet and a second packet used for the communication between two devices.

FIG. 8A and 8B depicts an exemplary method of communication between two devices.

FIG. 9 depicts an embodiment involving a second device sending a first device communications confirming receipt of a message, opening of a message, and deletion of a message.

FIG. 10 is an exemplary screenshot of an invitation screen on a device.

FIG. 11 depicts an embodiment involving sending a message and user ID in separate packets.

### DETAILED DESCRIPTION OF THE PREFERRED EMBODIMENTS

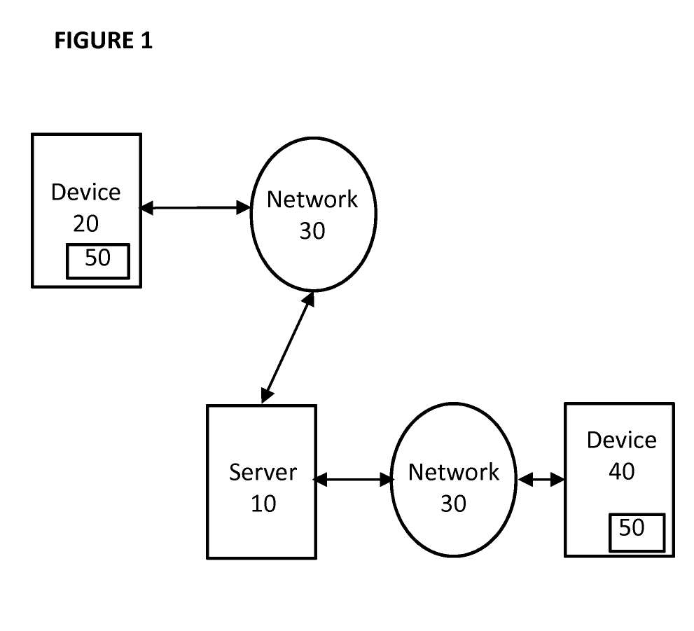

An embodiment is now described with reference to FIG. 1. Device 20 is coupled to server 10 over network 30. Device 40 also is coupled to server 10 over network 30 (or over a different network). Network 30 can be the Internet or a portion thereof. Device 20 and device 40 each can be an computing device capable of network connectivity, such as a mobile device, a tablet, desktop computer, laptop computer, or other device. Device 20, device 40, and server 10 each comprise at least one processor, memory (such as RAM), non-volatile storage (such as a disk drive or flash memory array), and a network interface. Device 20 and device 40 each comprise a screen, and server 10 optionally comprises a screen.

As discussed below, in one embodiment, server 10 facilitates communication between device 20 and device 40 in conjunction with an application 50 running on device 20 and device 40. Application 50 comprises lines of code executed by a processor within device 20 or device 40. In one embodiment, application 50 comprises a web browser. In another embodiment, application 50 comprises a customized application.

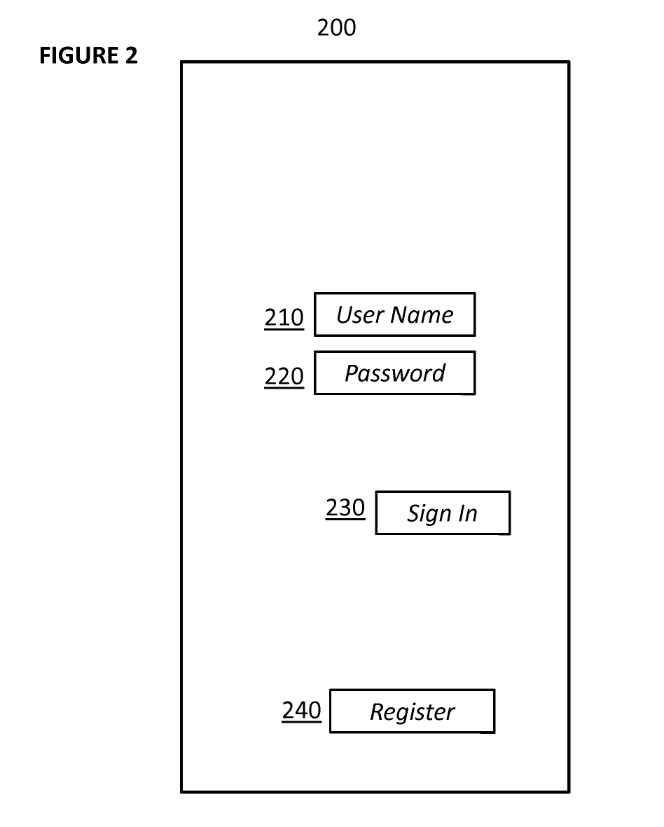

FIG. 2 depicts exemplary screenshot 200 that application 50 can generate on device 20 or device 40. Screenshot 200 is a login screen and displays input device 210 for the entry of a user name and input device 220 for the entry of a password, as is well known in the art. Input device 210 and input device 220 each can comprise an HTML text box or other input mechanism. Screenshot 200 also displays input device 230 (which optionally is an HTML link or button) for sign in, which the user selects after entering his or her user name and password. If the user has no user name and password, the user can select input device 240 (which optionally is an HTML link or button) to register and obtain a user name and password.

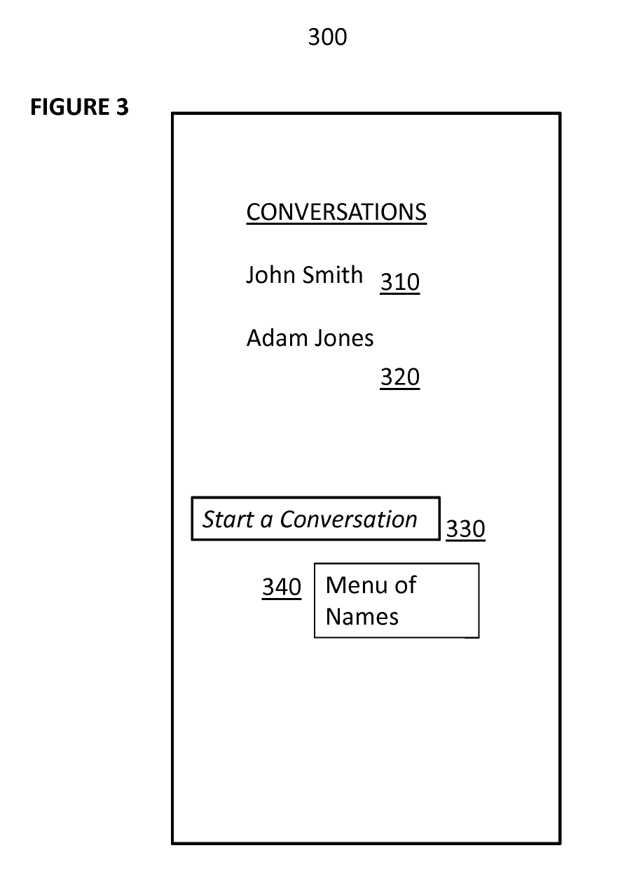

FIG. 3 depicts exemplary screenshot 300 that application 50 can generate on device 20 or device 40. The user is allowed to start a conversation by selecting input device 330, which can be an HTML button, link, etc. The user optionally is provided a menu 340 that here comprises a menu of known names with which the user has communicated in the past or that are in the user's contacts database. Also shown are representations 310 and 320 of ongoing or recent conversations, here with John Smith and Adam Jones.

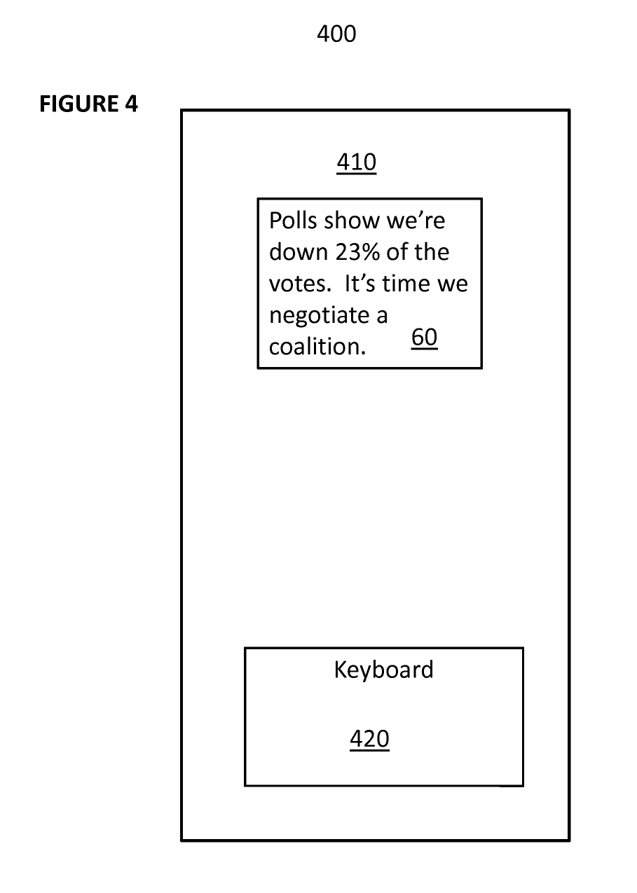

Once the user starts a conversation, a screenshot such as exemplary screenshot 400 in FIG. 4 is displayed. In this example, device 20 is a transmitting device and device 40 is a receiving device. Screenshot 400 is generated by application 50 running on device 20. The user of device 20 is provided a message box 410 in which to type a message 60 using keyboard 420, which in this example is provided graphically on a touch screen. Message 60 can comprise text. It also can comprise a photo or other file, which the user can select through a “browse” function that enables the user to upload a photo or other file.

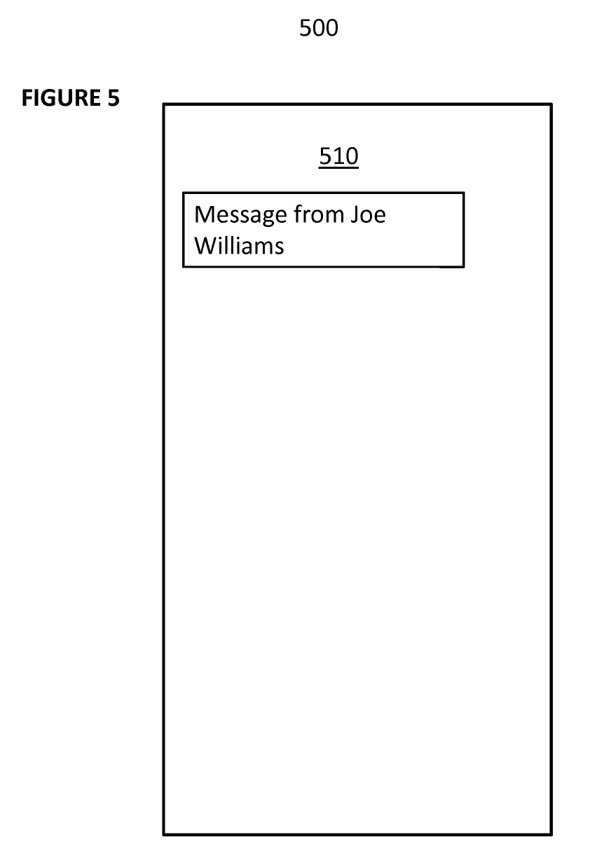

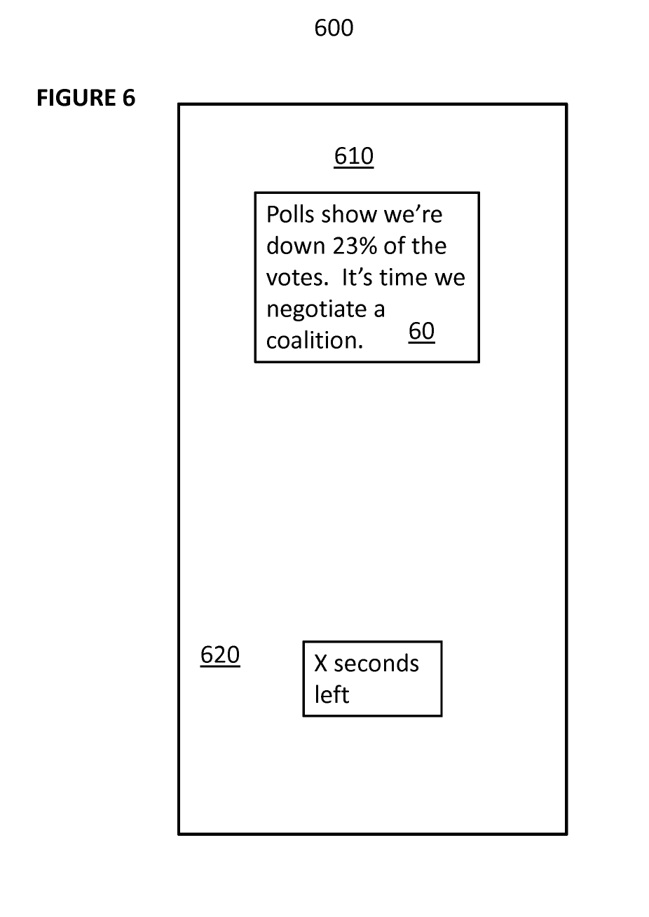

Message 60 is then transmitted to server 10 (as discussed below) and then to device 40. FIG. 5 depicts exemplary screen shot 500 that application 50 generates on device 40. Device 40 displays a prompt box 510 that here indicates that the user has received a “Message from Joe Williams.” The user can then select the message by pressing a button, link, etc. Optionally, screen shot 500 need not be used at all, and device 40 instead can just display a message as described with reference to FIG. 6.

FIG. 6 depicts exemplary screen shot 600 generated by application 50 running on device 40. Exemplary screen shot 600 displays message 60 without identifying the sender of message 60. For example, the sender's name is not listed on this screen. In this embodiment, the user is unable to select or copy message 60 on the screen.

The screen also displays an indication 620 that the message will disappear in X seconds. Here, X can be 10 seconds, 5 seconds, etc. After X seconds, message 60 disappears from the screen.

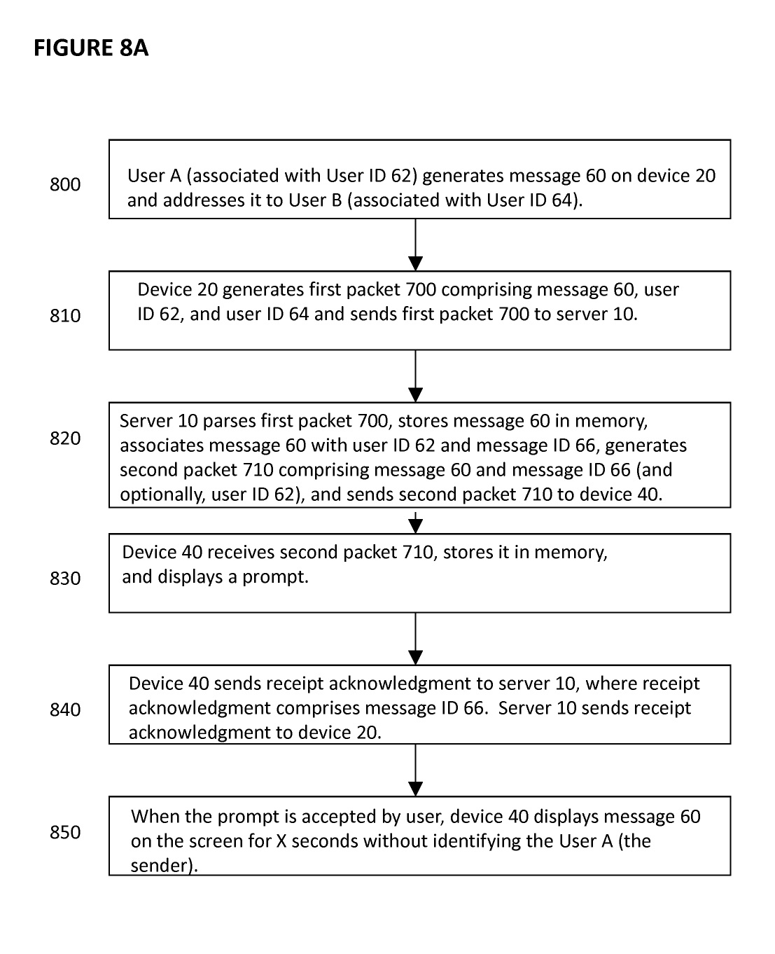

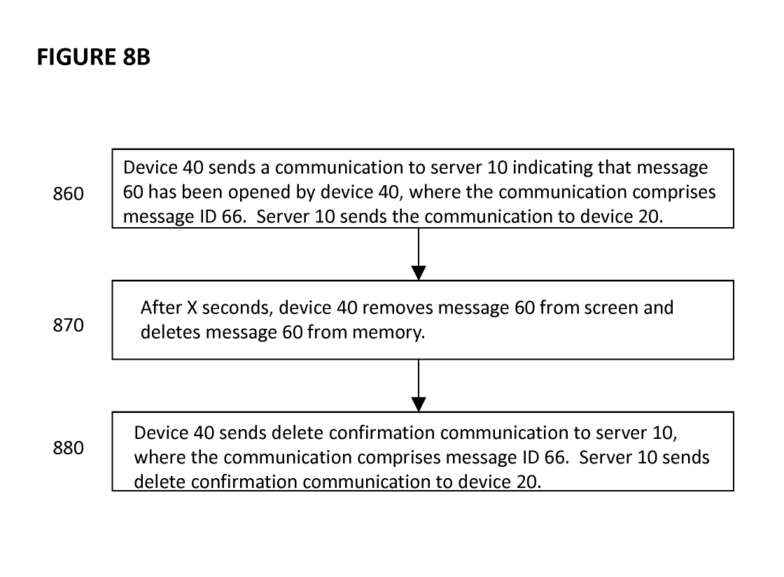

FIGS. 8A and 8B depict the steps of an embodiment. User A (associated with User ID 62) generates message 60 on device 20 and addresses it to User B (associated with User ID 64) (step 800). Device 20 generates first packet 700 comprising message 60, user ID 62, and user ID 64 and sends first packet 700 to server 10 (step 810). Optionally, message 60 is then deleted from device 20. Server 10 parses first packet 700, stores message 60 in memory, associates message 60 with user ID 62 and message ID 66, generates second packet 710 comprising message 60 and message ID 66 (and optionally, user ID 62), and sends second packet 710 to device 40 (step 820). Device 40 receives second packet 710, stores it in memory, and displays a prompt (step 830). Device 40 sends receipt acknowledgment to server 10, where receipt acknowledgment comprises message ID 66. Server 10 sends receipt acknowledgment to device 20 (step 840). When the prompt is accepted by user, device 40 displays message 60 on the screen for X seconds without identifying the User A (the sender) (step 850). Here, X can be a value set by User A through device 20, or it can be set by server 10. An example X is seven seconds. Device 40 sends a communication to server 10 indicating that message 60 has been opened by device 40, where the communication comprises message ID 66. Server 10 sends the communication to device 20 (step 860). After X seconds, device 40 removes message 60 from screen and deletes message 60 from memory (step 870). Device 40 sends delete confirmation communication to server 10, where the communication comprises message ID 66. Server 10 sends delete confirmation communication to device 20 (step 880).

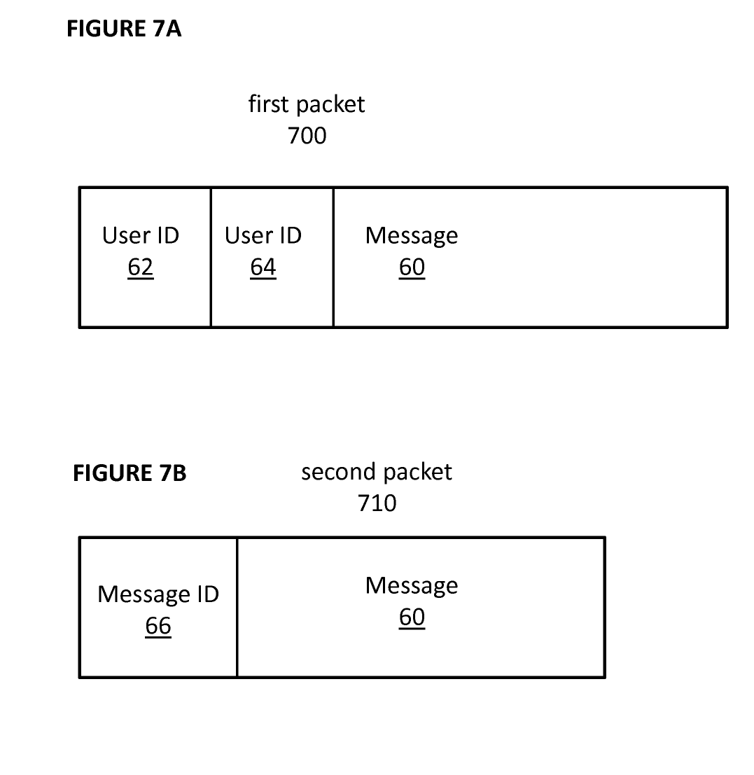

Examples of first packet 700 and second packet 710 are depicted in FIGS. 7A and 7B. First packet 700 comprises user ID 62, user ID 64, and message 60. Message 60 can comprise text, graphics, photos, or other files. Second packet 710 comprises message ID 66 and message 60 and optionally comprises user ID 62. If second packet 710 does not comprise user ID 62, then message 60 truly is anonymous because no identification information will be sent with message 60. First packet 700 and second packet 710 can be sent as user data according to the well-known HTTP communication protocol or other known network protocols.

In one embodiment, message ID comprises a plurality of UTF-8 characters (e.g., 8 characters) generated randomly or pseudo-randomly by server 10. The same message ID can be reused for different messages over time.

Optionally, the method of FIGS. 8A and 8B can be used for multiple recipients at one time, such as in a broadcast mode. This would require only that User A enter multiple User IDs for the recipients or enter a group name that can be correlated by server 10 to multiple User IDs.

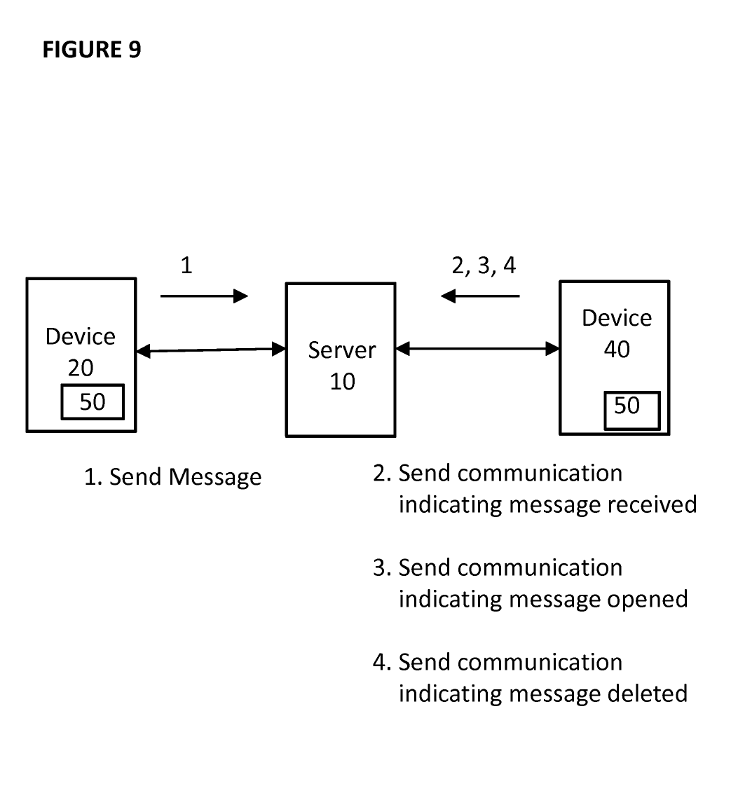

FIG. 9 depicts the communications sent from device 40 to device 20. For convenience, server 10 and network 30 are not shown. Device 20 sends message 60 to device 40. Device 40 sends a communication to device 20 indicating that message 60 was received. The user then opens message 60. Device 40 sends a communication to device 20 indicating that message 60 was opened. After a period of time X, message 60 is deleted from device 40. Device 40 sends a communication to device 20 indicating that message 60 was deleted. These communications are optional, and all three types need not be utilized. For example, a system could be implemented whereby deletion is confirmed but receipt and opening are not.

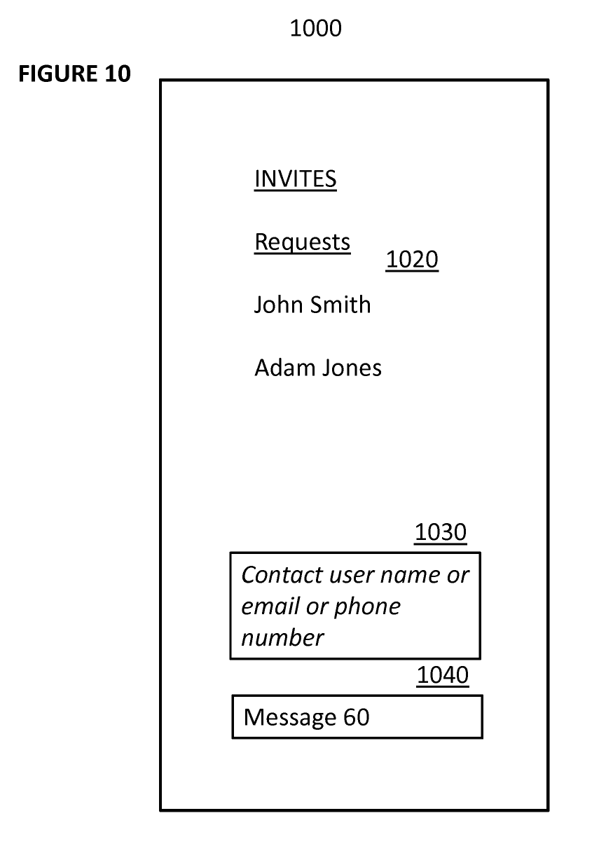

FIG. 10 depicts exemplary screen shot 1000 generated by application 50 running on device 20 or device 40. This screen is used to invite others to connect via the embodiment of this invention. The screen displays pending requests 1020. The screen also includes input device 1030 (such as an HTML textbox) that allows a user to input the user name (which can be a user ID such as user ID 62 or user ID 64), email address, or phone number of the person that they wish to invite. Optionally, input device 1040 allows the user to type message 60 for the invitee. Once a user enters that in input device 1030, server 10 will send an invitation to that person. If the user is not already registered with the system (i.e., if the user does not have a user ID), the invitation can be sent by email or SMS or MMS message. The email, SMS message, or MMS message optionally comprises a link to a web registration screen provided by server 10 or another server via standard web communication. When the user follows the link, he or she will be able to register to obtain a user ID. Once he or she obtains a user ID, message 60 will be displayed in the manner described above for FIGS. 8A and 8B. Optionally, message 60 can instead be shown on the web registration screen.

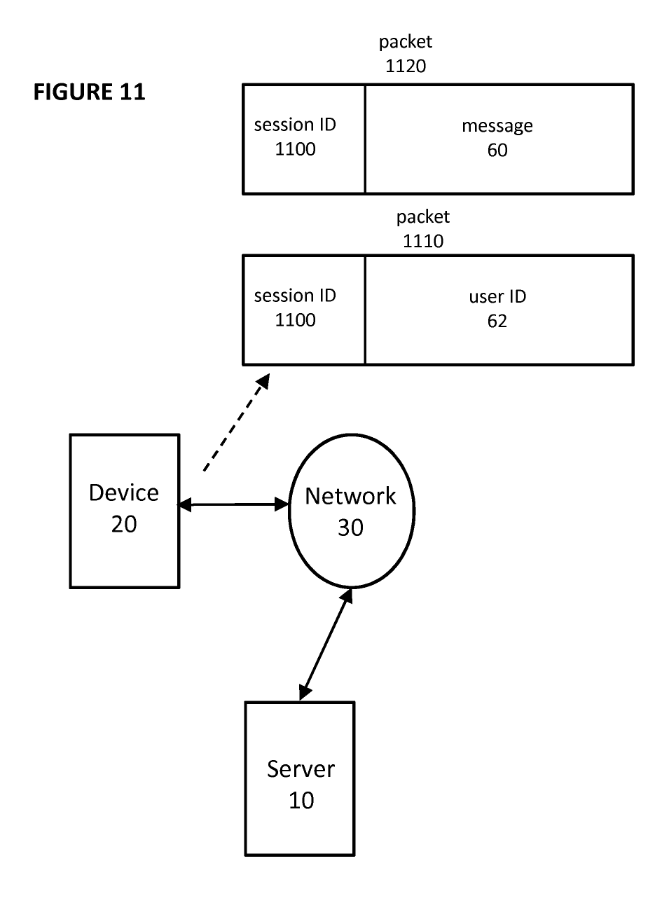

Another embodiment is shown in FIG. 11. For security purposes, message 60 is sent in packet 1120 from device 20 to network 30, but user ID 62 (the ID for the sender of message 60) is sent in packet 1110. The benefit of this embodiment is to provide an additional security layer for the system. If someone intercepts packet 1120 and attempts to decipher its contents, they will be unable to determine the identity or user ID of the sender of packet 1120. Packet 1110 and packet 1120 each comprise session ID 1100. When server 10 receives packet 1110 and packet 1120, it will be able to associate message 60 with user ID 62 by matching the session ID 1100 in packet 1110 and packet 1120. User ID 64 (the ID for the recipient of message 60) can be included in packet 1110, packet 1120, or in a third packet (not shown). Packet 1110 and packet 1120 can be sent as user data according to the well-known HTTP communication protocol or other known network protocols. Server 10 can then send message 60 to device 40 using the method described previously with regard to FIGS. 8A and 8B.

Another aspect of the aforementioned embodiments is that communication between device 20 and server 10 and between server 10 and device 40 can be encrypted using known encryption techniques, such as techniques available in SSL.

What is claimed is:

1. A device for receiving and displaying data, comprising:
a device configured to receive a message over a network, to display the message on a screen without identifying the sender of the message, and to delete the message from the device after a predetermined time period.

2. The device of claim 1, wherein the device is further configured to display the amount of time remaining in the predetermined time period.

3. The device of claim 1, wherein the device is further configured to transmit a confirmation communication of receiving the message.

4. The device of claim 1, wherein the device is further configured to transmit a confirmation communication of opening the message.

5. The device of claim 1, wherein the device is further configured to transmit a confirmation communication of deleting the message.

6. The device of claim 2, wherein the device is further configured to transmit a confirmation communication of receiving the message.

7. The device of claim 2, wherein the device is further configured to transmit a confirmation communication of opening the message.

8. The device of claim 2, wherein the device is further configured to transmit a confirmation communication of deleting the message.

9. The device of claim 3, wherein the device is further configured to transmit a confirmation communication of opening the message.

10. The device of claim 9, wherein the device is further configured to transmit a confirmation communication of deleting the message.

11. A method for receiving and displaying a message, comprising:
receiving, by a device, a message over a network;
displaying the message on a screen of the device without identifying a sender of the message; and,
deleting the message from the device after a predetermined time period.

12. The method of claim 11, further comprising displaying the amount of time remaining in the predetermined time period.

13. The method of claim 11, further comprising transmitting a confirmation communication of receiving the message.

14. The method of claim 11, further comprising transmitting a confirmation communication of opening the message.

15. The method of claim 11, further comprising transmitting a confirmation communication of deleting the message.

16. The method of claim 12, further comprising transmitting a confirmation communication of receiving the message.

17. The method of claim 12, further comprising transmitting a confirmation communication of opening the message.

18. The method of claim 12, further comprising transmitting a confirmation communication of deleting the message.

19. The method of claim 13, further comprising transmitting a confirmation communication of opening the message.

20. The method of claim 19, further comprising transmitting a confirmation communication of deleting the message.
